(19) United States
(12) Patent Application Publication
(10) Pub. No.: US 2020/0321175 A1
(43) Pub. Date: Oct. 8, 2020

(54) SWITCH DEVICE AND PROTECTIVE DEVICE

(71) Applicant: DEXERIALS CORPORATION, Tokyo (JP)

(72) Inventors: Yuji FURUUCHI, Tochigi (JP); Yoshihiro YONEDA, Tochigi (JP); Koichi MUKAI, Tochigi (JP); Kazuyuki SAKAKIBARA, Aichi (JP)

(73) Assignee: DEXERIALS CORPORATION, Tokyo (JP)

(21) Appl. No.: 16/910,661

(22) Filed: Jun. 24, 2020

Related U.S. Application Data
(62) Division of application No. 15/766,848, filed on Apr. 9, 2018.

(30) Foreign Application Priority Data
Oct. 7, 2015 (JP) 2015-199814

(51) Int. Cl. H01H 35/18; H01H 35/42; H01H 35/00; H01H 85/00; H01H 87/00; H01H 89/00; H01M 2/34; H01M 10/42

(52) U.S. Cl. CPC H01H 35/183; H01H 35/42; H01H 35/00; H01H 35/18; H01H 85/0047; H01H 87/00; H01M 2200/103; H01M 2/348; H01M 10/4257; H01M 2200/00; H01H 2225/014; H01H 2239/03; H01M 2010/4271; H01H 89/00

(57) ABSTRACT

A switch device capable of safely opening or short-circuiting an electrical circuit in response to an abnormality such as wetting with water or liquid leaking from a battery is provided. The device includes a conductor connected to an external circuit, and a reaction part including a liquid-soluble material which opens the conductor and the external circuit and which dissolves on contacting a liquid entering the device interior to electrically connect the conductor and the external circuit.

### CROSS-REFERENCE TO RELATED APPLICATION(S)

This application is a divisional of U.S. application Ser. No. 15/766,848 filed Apr. 9, 2018, which is a National Stage Entry of PCT/JP2016/079597 filed on Oct. 5, 2016, which is based on and claims priority under 35 U.S.C. 119 from Japanese Patent Application No. 2015-199814 filed on Oct. 7, 2015. The contents of the above applications are incorporated herein by reference.

### TECHNICAL FIELD

The present disclosure relates to a switch device for opening or short-circuiting an electrical circuit in response to entrance of a liquid and a protective device for opening an electrical circuit in response to entrance of a liquid. This application claims priority to Japanese Patent Application No. 2015-199814 filed on Oct. 7, 2015, the entire contents of which are hereby incorporated by reference.

### BACKGROUND ART

In recent years, lithium ion secondary batteries have been incorporated in a large number of mobile phones and laptops, among other electronic appliances. Lithium ion secondary batteries have high energy densities and, to ensure the safety of users and electric appliances, are typically provided with several protective circuits incorporated in the battery pack for over-charging protection and over-discharging protection to interrupt the input and output of the battery pack under predetermined conditions. However, if a positive/negative electrode insulation fitting portion were to be corroded by being wet, there is a possibility that pressure from the interior of the battery might leak and a safety valve might malfunction to cause a fire.

### CITATION LIST

### Patent Literature

PLT 1: Japanese Unexamined Patent Application Publication No. H11-144695

PLT 2: Japanese Unexamined Patent Application Publication No. 2000-162081

### SUMMARY OF INVENTION

### Technical Problem

Some batteries have employed seals applied for detecting evidence of and providing a warning for exposure to water (for example, see PLT 1); however, battery use is not restricted, potentially creating a risk of a circuit malfunction caused, for example, by migration (degraded insulation) or short circuits due to a wet circuit substrate. Furthermore, a malfunction equivalent to that described above might occur in the case of leaking electrolyte solution accompanying a battery abnormality.

As a measure for wetting of electronic appliances with water, sensors for detecting liquids such as water have been provided which activate a protective circuit by transmitting a signal from the sensor when detecting water. For example, a water leak sensor having a detector constituted by a pair of electrodes disposed on an insulating substrate to face each other across a predetermined interval has been proposed (for example, see PLT 2). In this water leak sensor, when there is water between the electrodes of the detector, electricity leaking between terminals causes a signal to be input to a control circuit to control operation of the device. Because liquid has to enter into the detector to trigger operation, this water wetting sensor requires a configuration to actively draw water into the detector in a wet state; however, in states other than the wet state, in which activating the control circuit is unnecessary, the sensor must avoid improper activation so as to ensure reliability as a sensor.

In view of such conventional circumstances, an object of the present disclosure is to provide a switch device capable of safely and reliably short-circuiting an external circuit in response to an abnormality such as wetting with water or liquid leaking from a battery, and a protective device for safely and reliably opening an external circuit in response to an abnormality such as wetting with water or liquid leaking from a battery.

### Solution to Problem

In order to solve the above problem, a switch device according to the present disclosure includes a conductor connected to an external circuit and a reaction part including a liquid-soluble material which opens the conductor and the external circuit and which dissolves on contacting a liquid entering an interior of the device to electrically connect the conductor and the external circuit.

Furthermore, a protective device according to the present disclosure includes an insulating substrate, a first and a second electrode provided on the insulating substrate, a heat generator provided on the insulating substrate, a fusible conductor which is connected between the first and second electrodes and which is blown out by heat generated by the heat generator, and a switch part provided on a power supply path of the heat generator, wherein the switch part includes a conductor connected to a power source circuit of the heat generator, and a reaction part comprising a liquid-soluble material which opens the conductor and the power source circuit and which electrically connects the conductor and the power source circuit by being dissolved on contact with a liquid entering the device.

### Advantageous Effects of Invention

According to the present disclosure, when an abnormality such as wetting with water or liquid leaking from a battery occurs, a reaction part including a liquid-soluble material causes the liquid to dissolve the liquid-soluble material to bring a conductor and an open end of the external circuit into contact to allow current to flow through the external circuit.

### BRIEF DESCRIPTION OF DRAWINGS

FIG. 1 is a schematic view illustrating a configuration of a switch device according to the present disclosure.

FIG. 2 is a diagram illustrating a switch device using a twisted wire as a conductor.

FIG. 3 is a cross-sectional view illustrating a switch device using a sponge metal as a conductor.

FIG. 4(A) is an external perspective view illustrating an agglomerated body of conductive particles coated with a liquid-soluble material, and FIG. 4(B) is a cross-sectional view illustrating a switch device employing the agglomerated body illustrated in 4(A) as a conductor.

FIG. 5 is an external perspective view illustrating an example in which a tube-shaped outer conductor and an inner conductor both made of an electrically conductive material are used as a conductor.

FIG. 6(A) is a cross-sectional view illustrating a state in which an insulating coating layer made of a liquid-soluble material is formed on an inner surface of an outer conductor, and FIG. 6(B) is a cross-sectional view illustrating a state in which an insulating coating layer made of a liquid-soluble material is formed on an outer surface of an inner conductor.

FIG. 7 is a cross-sectional view illustrating a state in which an insulating film made of a liquid-soluble material is interposed between an outer conductor and an inner conductor.

FIGS. 8(A)-8(D) illustrate a housing of a switch device in perspective views of 8(A) a configuration having a guiding inlet formed on a top surface, 8(B) a configuration having a plurality of guiding inlets formed on a top surface, 8(C) a configuration having a guiding inlet on a top surface and a side surface, and 8(D) a configuration having a plurality of guiding inlets formed on a top surface and side surfaces.

FIG. 9 is a perspective view illustrating a switch device employing a round tube-shaped housing.

FIGS. 10(A)-10(B) illustrate a switch device employing a housing having a discharging outlet in perspective views in which 10(A) one guiding inlet is formed on a top surface of the housing and 10(B) a plurality of guiding inlets are formed on a top surface of the housing.

FIG. 11 is a cross-sectional view illustrating a switch device in which a discharging outlet is provided at the same height as a reaction part or provided at a position higher than the reaction part.

FIG. 12 is a cross-sectional view illustrating a switch device employing a housing in which a slit-shaped guiding inlet and a slit-shaped discharging outlet are formed.

FIGS. 13(A)-13(B) illustrate a switch device employing a housing provided with a guiding conduit in 13(A) a cross-sectional view and 13(B) an external perspective view.

FIGS. 14(A)-14(B) illustrate a switch device employing a housing in which a plurality of guiding inlets and guiding conduits are formed in 14(A) a cross-sectional view and 14(B) an external perspective view.

FIG. 15 is a cross-sectional view illustrating a switch device employing a housing having a guiding conduit which progressively narrows towards the interior in which a reaction part is provided.

FIG. 16 is a perspective view illustrating a switch device employing a housing having guiding inlets formed at heights corresponding to positions of a conductor and a reaction part.

FIG. 17 is a perspective view illustrating a switch device employing a housing having a water repellent treatment portion formed in a location other than the reaction part.

FIG. 18 is a perspective view illustrating a switch device employing a housing in which a guiding inlet is sealed with a water-soluble sealing material.

FIG. 19 is a cross-sectional view illustrating a switch device employing a housing in which a guiding conduit is blocked with a water-soluble sealing material.

FIGS. 20(A)-20(B) illustrate a switch device in which a wiring conduit is formed for arranging a twisted wire on a surface to be butted of a half of a housing in 20(A) a cross-sectional view and 20(B) a perspective view illustrating a lead recess through which the twisted wire is led into and out of the housing.

FIG. 21 is a perspective view illustrating a state in which a twisted wire is led out from a lead recess of a wiring conduit.

FIGS. 22(A)-22(B) illustrate a switch device in which a wiring conduit is formed for arranging a twisted wire on a surface to be butted of a half of a housing in 22(A) a cross-sectional view and 22(B) a perspective view illustrating a lead recess through which a twisted wire is led into the housing.

FIGS. 23(A)-23(B) are a circuit diagram of a switch device connected to an external circuit representing 23(A) the switch device before activation and 23(B) the switch device after activation.

FIGS. 24(A)-24(B) represent states of a switch device connected to a protective device in circuit diagrams in which 24(A) a protective device has separate circuit paths for the current path of a heat generator and a fuse element and 24(B) a protective device has a heat generator connected to a fuse.

FIG. 25 is a circuit diagram of a battery back incorporating a switch device and a protective device.

FIGS. 26(A)-26(B) represent a protective device incorporating a switch device in circuit diagrams in which 26(A) the protective device has separate circuit paths for the current paths of a heat generator and fuse element and 26(B) a protective device has a heat generator connected to a fuse element.

### DESCRIPTION OF EMBODIMENTS

Embodiments of a switch device and a protective device according to the present disclosure will now be more particularly described with reference to the accompanying drawings. It should be noted that the present disclosure is not limited to the embodiments described below and it is a matter of course that various modifications can be added to the embodiments without departing from the scope of the present disclosure. Furthermore, the features illustrated in the drawings are illustrated schematically and are not intended to be drawn to scale. Actual dimensions should be determined in consideration of the following description. Moreover, those skilled in the art will appreciate that dimensional relations and proportions may be different among the drawings in some parts.

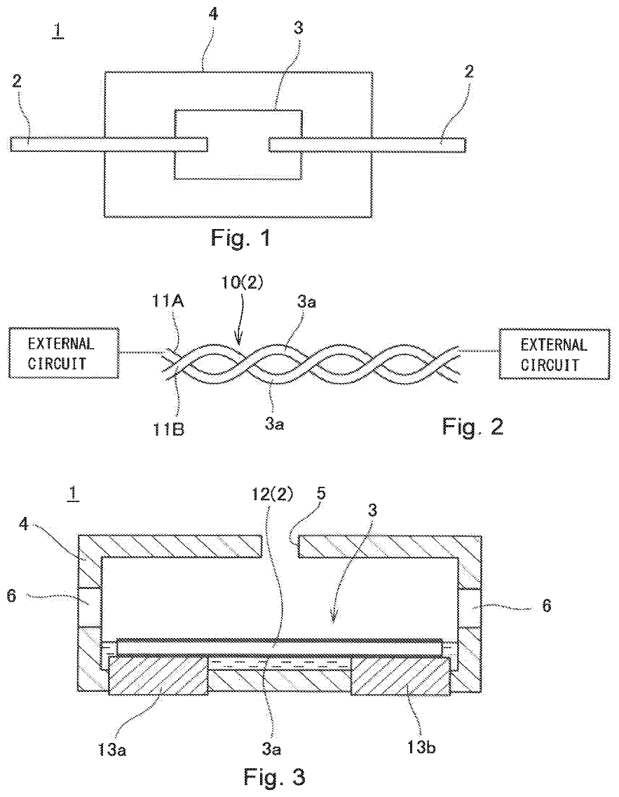

A switch device according to the present disclosure is incorporated into an external circuit, such as a battery circuit or warning circuit, and interrupts the battery circuit or powers the warning circuit or a protective circuit in a wet state such as in the case of submersion in water or liquid leakage. As illustrated in FIG. 1, a switch device 1 includes a conductor 2 connected to an external circuit and a reaction part 3 provided with a liquid-soluble material 3a coating the conductor 2 which opens the external circuit, and which electrically connects the external circuit by being dissolved on contact with a liquid entering the interior of the device, the conductor 2 and the reaction part 3 being housed within a housing 4.

Conductor

The conductor 2 is a component which, by being connected between open ends of an external circuit into which the switch device 1 is incorporated, electrically connects the external circuit, and as the conductor 2, for example, lead wires and sponge metals, among other known electrically conductive components may be used.

In the switch device 1, a connecting end of the conductor 2 is led to the exterior of the housing 4 and can be connected with a terminal portion of the external circuit. Moreover, the switch device 1 may be connected to the external circuit by connecting the conductor 2 to an electrode which is formed on an insulating substrate provided in the housing 4 and which is connected to an open terminal of the external circuit.

Under normal conditions the conductor 2 of the switch device 1 is electrically insulated from the external circuit by being coated with the liquid-soluble material 3a constituting the reaction part 3; by liquid contacting the reaction part 3, the liquid-soluble material 3a coating the conductor 2 is dissolved and current can flow through the external circuit via the conductor 2.

For example, as illustrated in FIG. 2, as the conductor 2, a twisted wire 10 of a pair of conductive wires 11A, 11B each connected to the external circuit may be used. The conductive wires 11A, 11B are electrically insulated from each other by each being coated with the liquid-soluble material 3a. The conductive wire 11A is connected to one free end of a current path of the external circuit to which the switch device 1 is connected, and the conductive wire 11B is connected to the other free end of the same current path. Thus, the external circuit is normally open.

Reaction Part

The reaction part 3 is for irreversibly electrically connecting the conductor 2 by contacting a liquid and includes the liquid-soluble material 3a coating the conductor 2. As the liquid-soluble material 3a, any electrically insulating material which dissolves on contact with a liquid may be used; examples include natural polymers such as agar and gelatin, semisynthetic polymers such as cellulose and starch, and synthetic polymers such as polyvinyl alcohol. Moreover, water-soluble solids such as solidified sugar which dissolve on contact with a liquid may be used as the liquid-soluble material 3a.

Furthermore, assuming an electrolyte solution such as of ethylene carbonate filling a battery cell as the liquid, in the case of a switch device for activating in response to leaking battery electrolyte solution, examples of the liquid-soluble material 3a include ABS, polyacrylonitrile, polyvinylidene fluoride, saturated polyesters such as PET, PTT, and PEN, among others. In these liquid-soluble materials 3a, because there are cases in which high molecular weights reduce dissolution rates and thus might reduce reaction rates in the switch device 1, when giving priority to reaction rates, it is preferable to adjust the degree of polymerization.

The liquid-soluble material 3a coating the conductor 2 constitutes the reaction part 3 within the housing 4. In the reaction part 3, when an abnormality occurs, such as wetting with water or liquid leaking from a battery, the liquid-soluble material 3a is dissolved by liquid entering the housing 4; this brings the conductor 2 and the open end of the external circuit into contact, thus electrically connecting the external circuit.

For example, by coating the pair of conductive wires 11A, 11B described above with the liquid-soluble material 3a, the reaction part 3 opens the external circuit by normally providing electrical insulation. Then, when an abnormality such as wetting with water or liquid leaking from a battery occurs, liquid entering the housing 4 contacts and dissolves the liquid-soluble material 3a of the reaction part 3, connecting the pair of conductive wires 11A, 11B and allowing current to flow through the external circuit.

### Alternative Examples of the Conductor

Referring now to FIG. 3, the switch device 1 may employ a sponge metal 12 as the conductor 2. The sponge metal 12 is coated with the liquid-soluble material 3a and mounted between a pair of external-connection terminals 13a, 13b provided in the housing 4 and connected to open ends of the external circuit. The external-connection terminals 13a, 13b are, for example, metal terminals provided in the housing 4 or are a conductive pattern formed on the housing 4 or on an insulating substrate arranged in the housing 4.

In the switch device 1, the sponge metal 12 is mounted to the external-connection terminals 13a, 13b via the liquid-soluble material 3a coating the surface of the sponge metal 12 and normally opens the external circuit. Then, in the switch device 1, when an abnormality occurs, such as wetting with water or liquid leaking from a battery, liquid entering the housing 4 contacts and dissolves the liquid-soluble material 3a, thereby electrically connecting the sponge metal 12 and the external-connection terminals 13a, 13b and allowing current to flow through the external circuit.

It should be noted that, in addition to the sponge metal 12, a porous body such as that of woven or nonwoven fabric using electrically conductive fiber or metal meshes as well as metal sheets such as metal films may be used as the conductor 2 and coated with the liquid-soluble material 3a.

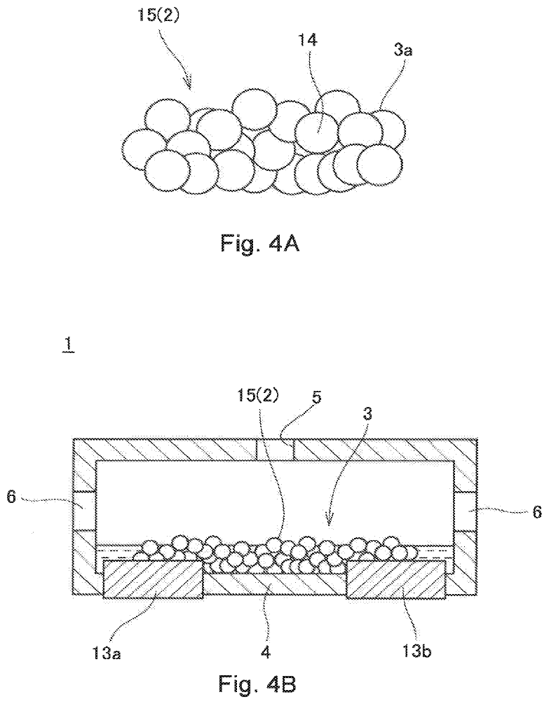

Furthermore, as illustrated in FIG. 4 (A), the switch device 1 may employ an agglomerated body 15 of conductive particles 14 coated with the liquid-soluble material 3a as the conductor 2. The agglomerated body 15 is held in a substantially sheet or film shape by the liquid-soluble material 3a coated to the individual conductive particles 14 and, as illustrated in FIG. 4 (B), is mounted between external-connection terminals 13a, 13b which are metal terminals provided in the housing 4 or are a conductive pattern formed on the housing 4 or on an insulating substrate provided in the housing 4.

In the switch device 1, the agglomerated body 15 of conductive particles 14 is mounted to the external-connection terminals 13a, 13b via the liquid-soluble material 3a coating the surface of the agglomerated body 15 and normally opens the external circuit. Then, in the switch device 1, when an abnormality occurs, such as wetting with water or liquid leaking from a battery, liquid entering the housing 4 contacts and dissolves the liquid-soluble material 3a, thereby electrically connecting both terminals via the conductive particles 14, which are continuous between the external-connection terminals 13a, 13b, and allowing current to flow through the external circuit.

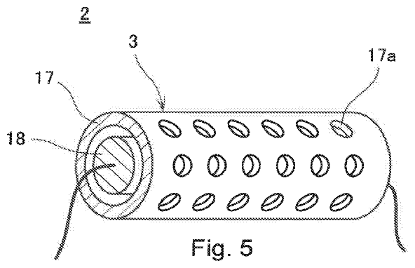

Furthermore, as illustrated in FIG. 5, the switch device 1 may employ a tube-shaped outer conductor 17 made of a conductive material and an inner conductor 18 made of a conductive material and provided inside the outer conductor 17 as the conductor 2. In the conductor 2 illustrated in FIG. 5, the outer conductor 17 is connected to one open end of the external circuit and the inner conductor 18 is connected to the other open end of the external circuit. The outer conductor 17 is, for example, a round tube-shaped conductor, and has one or a plurality of openings 17a formed on an outer circumferential surface thereof through which liquid enters. It should be noted that the outer conductor 17 may be any hollow shape other than the round tube shape as long as it can receive the inner conductor 18.

So long as allowing arrangement within the outer conductor 17, the inner conductor 18 may be any shape and, in addition to the column shape illustrated in FIG. 5, may be a prism, a wrapped sheet shape, or a block shape, among others. Moreover, the inner conductor 18 is movably held inside the outer conductor 17.

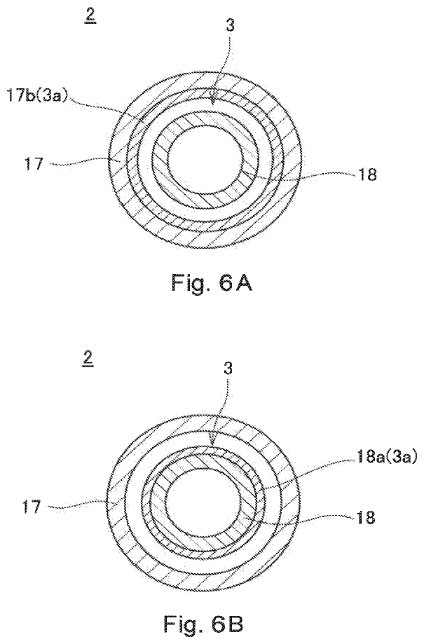

In the switch device 1, as illustrated in FIG. 6 (A), an electrically insulating coating layer 17b is formed by the liquid-soluble material 3a on the inner surface of the outer conductor 17, this insulates the outer conductor 17 and the inner conductor 18 under normal conditions and opens the external circuit. Then, in the switch device 1, when an abnormality such as wetting with water or liquid leaking from a battery occurs, liquid entering the housing 4 enters through the opening 17a of the outer conductor 17 and contacts the liquid-soluble material 3a so that the insulating coating layer 17b dissolves, thus connecting the outer conductor 17 and the inner conductor 18 and allowing current to flow through the external circuit.

It should be noted that, in the switch device 1, as illustrated in FIG. 6 (B), the liquid-soluble material 3a may be applied to the outer surface of the inner conductor 18 to form an insulating coating layer 18a. The insulating coating layer 18a dissolves on contact with liquid entering via the openings 17a of the outer conductor 17, thereby electrically connecting the outer conductor 17 and the inner conductor 18.

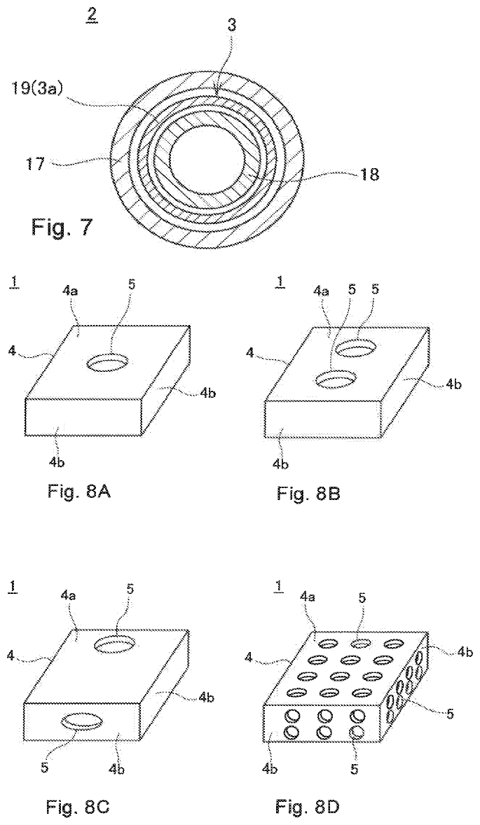

Furthermore, as illustrated in FIG. 7, the switch device 1 may have an electrically insulating film 19 made of the liquid-soluble material 3a interposed between the outer conductor 17 and the inner conductor 18. The insulating film 19 is of a size and shape sufficient to shield the inner conductor 18 from the inner surface of the outer conductor 17 and electrically insulates the outer conductor 17 and the inner conductor 18 from each other under normal conditions. Then, when an abnormality occurs, such as wetting with water or liquid leaking from a battery, the insulating film 19 is dissolved on contact with liquid entering the housing 4 and the openings 17a of the outer conductor 17, thereby connecting the outer conductor 17 and the inner conductor 18.

Housing

The housing 4 of the switch device 1 can be formed from an electrically insulating material such as various engineering plastics and ceramics, among other materials. By providing the switch device 1 with the housing 4, the conductor 2 and reaction part 3 can be protected.

A guiding inlet 5 is provided in the housing 4 for guiding liquid to the reaction part 3. Liquid entering the reaction part 3 via the guiding inlet 5 provided in the housing 4 causes the switch device 1 to irreversibly connect the conductor 2.

For example, as illustrated in FIG. 8 (A), the housing 4 is polyhedral and has one guiding inlet 5 on one surface. In the case of forming the switch device 1 as a chip component for mounting on a circuit substrate on which the external circuit is formed, it is preferable to provide the guiding inlet 5 on a top surface 4a on a side opposite to a mounting surface of the housing 4. Providing the guiding inlet 5 on the top surface 4a allows efficient intake of liquid into the housing 4 in a wet state and allows retention of liquid in the reaction part 3, enabling connection of the conductor 2. It is a matter of course that the housing 4 may have the guiding inlet 5 on a surface other than the top surface 4a, for example, a side surface 4b. Furthermore, as illustrated in FIG. 8 (B), the housing 4 may have a plurality of guiding inlets 5 on the top surface 4a or may have a plurality of guiding inlets 5 on the side surface 4b. Providing the plurality of guiding inlets 5 in the housing 4 can promote guidance of water to the reaction part 3.

Moreover, as illustrated in FIG. 8 (C), the housing 4 may be polyhedral and have the guiding inlet 5 on a plurality of surfaces, for example, on a top surface 4a and a side surface 4b. Furthermore, as illustrated in FIG. 8 (D), the housing 4 may have one or a plurality of guiding inlets 5 on each of a plurality of surfaces.

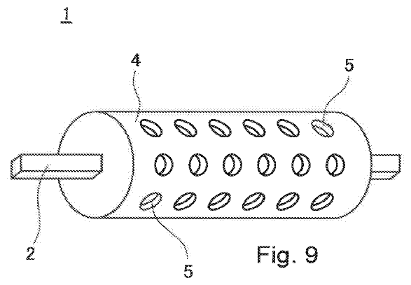

The housing 4 may be a cylindrical shape or a prism shape and the guiding inlet 5 may be formed in any position and in any number. FIG. 9 is an external perspective view of the switch device 1 in which the housing 4 is formed in a cylindrical shape and a plurality of the guiding inlets 5 are formed around the entire circumference. By forming the housing 4 in a cylinder or prism shape, the guiding inlets 5 can be formed irrespective of surfaces/angles and liquid entrance path which would otherwise depend on orientation of the switch device 1.

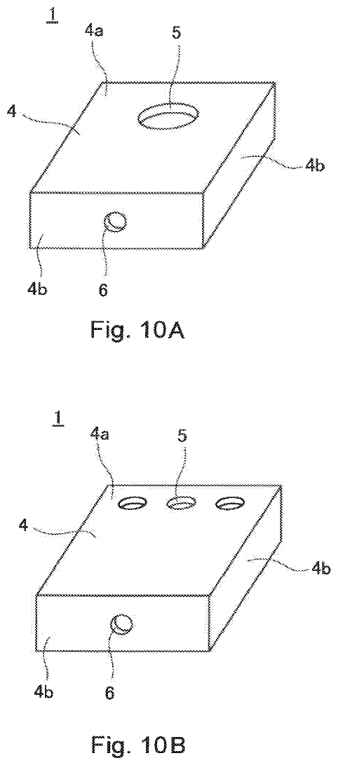

A discharging outlet may be formed in the housing 4 for discharging liquid entering via the guiding inlet 5. FIG. 10 is an external perspective view illustrating the switch device 1 provided with the housing 4 in a polyhedral shape having the guiding inlet 5 formed on the top surface 4a and a discharging outlet 6 for discharging liquid formed on the side surface 4b. Forming the discharging outlet 6 can prevent situations in which the dissolution reaction of the liquid-soluble material 3a is reduced due to influences such as cooling caused by a large amount of liquid entering the housing 4.

The discharging outlet 6 is preferably formed smaller than the guiding inlet 5. By making the discharging outlet 6 relatively small, it is possible to prevent excessive discharge of liquid entering the housing 4 from causing a delay in the action of the reaction part 3 or in the electrical connection of the conductor 2.

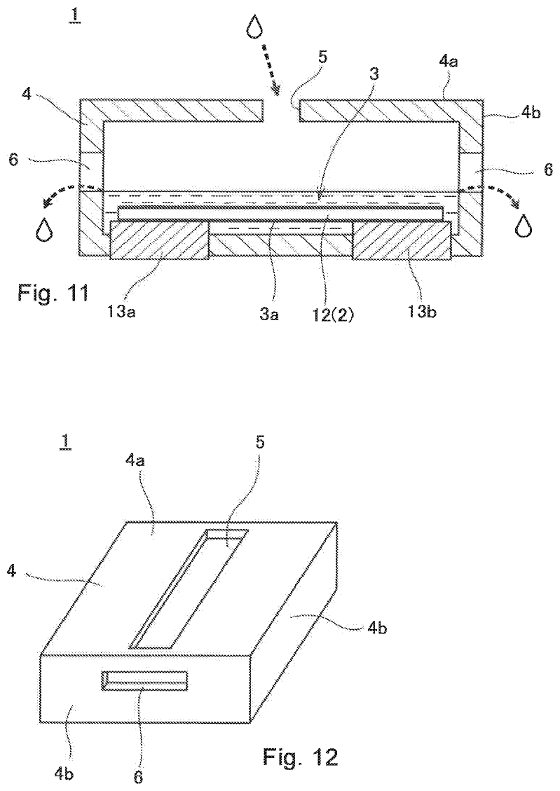

Furthermore, it is preferable to provide the discharging outlet 6 at the same height as the position at which the reaction part 3 of the housing 4 is provided, or higher than the position at which the reaction part 3 is provided. For example, as illustrated in FIG. 11, the housing 4 is formed in a polyhedral shape and, in the case of being formed as a chip component on a circuit substrate, it is preferable to provide the discharging outlet 6 on the side surface 4b of the housing 4 at the same height or above the position at which the reaction part 3 is provided. Thereby, liquid entering the housing 4 remains in the reaction part 3 while portions above the reaction part 3 are drained, which can ensure action of the reaction part 3 and prevent a situation in which the dissolution reaction of the liquid-soluble material 3a is reduced due to influences such as cooling caused by a large amount of liquid entering the housing 4.

The guiding inlet 5 for guiding liquid and the discharging outlet 6 for discharging liquid may be any shape, for example, circular or rectangular. Furthermore, as illustrated in FIG. 12, the guiding inlet 5 and the discharging outlet 6 may be formed in a slit shape. Forming the guiding inlet 5 in a slit shape can guide liquid over a wider range, enabling rapid reaction in the reaction part 3 and electrical connection of the conductor 2. Moreover, by forming the discharging outlet 6 in a slit shape, it is possible to rapidly drain excess liquid entering the housing 4 and prevent influences, such as cooling caused by a large amount of liquid entering the housing 4, from reducing the dissolution reaction of the liquid-soluble material 3a.

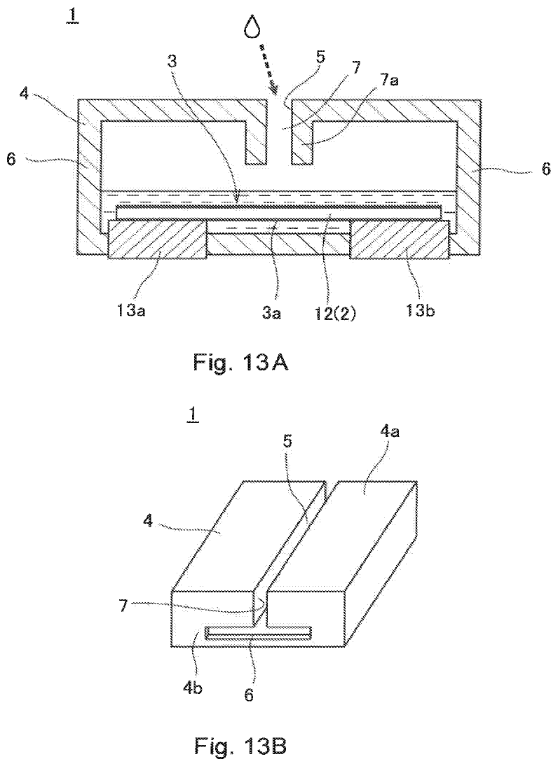

In addition to providing the housing 4 with a slit-shaped guiding inlet 5 on the top surface 4a, the housing 4 may be provided with a guiding conduit 7 for guiding the liquid to the reaction part 3. As illustrated in FIG. 13 (A), the guiding conduit 7 includes a conduit wall 7a extending from the guiding inlet 5 formed in the top surface 4a to the vicinity of the reaction part 3. This ensures that liquid entering the housing 4 via the guiding inlet 5 is guided to the reaction part 3 and does not flow to locations other than the reaction part 3. This also prevents scattering of liquid entering the housing 4 through the guiding inlet 5, thus preventing delays in electrically connection of the conductor 2 by the reaction part 3.

Furthermore, as illustrated in FIG. 13 (B), the guiding conduit 7 of the housing 4 may extend to the side surface 4b and be continuous with the discharging outlet 6 formed in the side surface 4b. Thereby, in the housing 4, liquid entering via the guiding inlet 5 can be effectively guided to the reaction part 3 and excess liquid can be effectively drained via the discharging outlet 6.

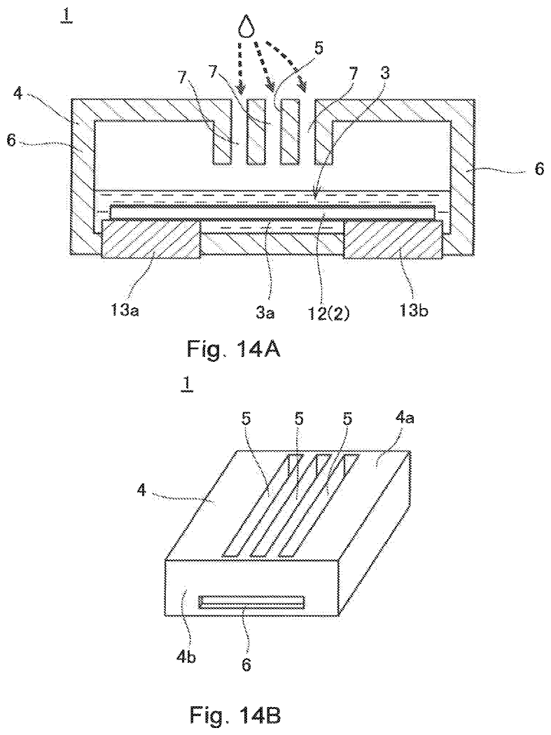

As illustrated in FIGS. 14 (A) and (B), a plurality of the guiding inlets 5 and the guiding conduits 7 may be formed. By forming a plurality of the guiding conduits 7, it is possible to guide the liquid to the entire width of the reaction part 3.

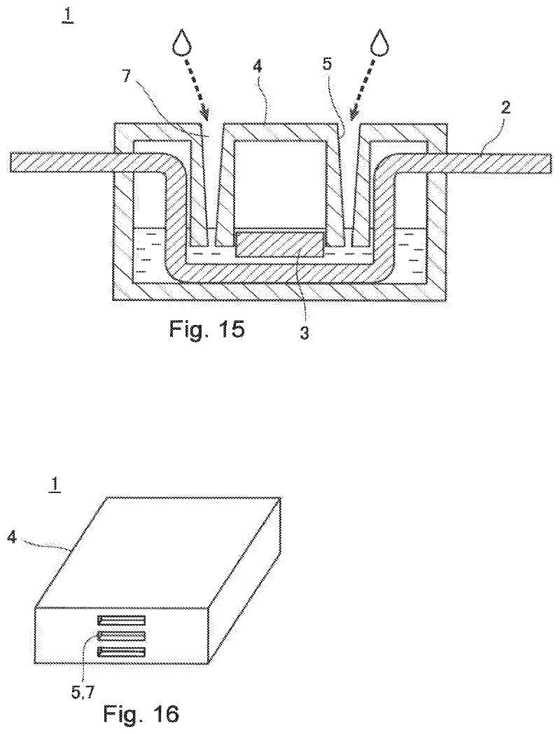

Furthermore, as illustrated in FIG. 15, in the switch device 1, the guiding conduit 7 may progressively narrow from the opening of the guiding inlet 5 in the top surface 4a towards the interior in which the reaction part 3 is provided. By the guiding conduit 7 tapering as it approaches the reaction part 3, capillary action can effectively guide liquid entering via the opening of the guiding inlet 5 to the reaction part 3.

Furthermore, in the switch device 1, as illustrated in FIG. 16, the guiding inlet 5, or the guiding inlet 5 and the guiding conduit 7, may be formed in the housing 4 in a position corresponding to the conductor 2 and the reaction part 3. In the switch device 1, for example, as in the example configuration of the conductor 2 and reaction part 3 illustrated in FIG. 3, in addition to mounting the sponge metal 12 coated with the liquid-soluble material 3a between the external-connection terminals 13a, 13b, the guiding inlet 5, or the guiding inlet 5 and the guiding conduit 7, may be formed in the side surface 4b at a height corresponding to the position of the sponge metal 12.

Forming the guiding inlet 5 in a position corresponding to the position of the reaction part 3 in the switch device 1 can effectively guide large amounts of liquid to the conductor 2 and reaction part 3 via the guiding inlet 5, make reactions in the reaction part 3 effective, and promote electrical connection of the conductor 2.

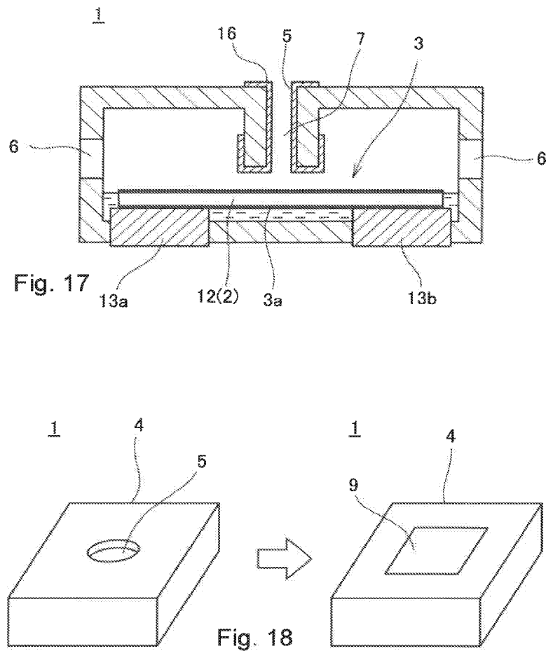

Furthermore, in the switch device 1, liquid may be led to the reaction part 3 by subjecting a location other than the reaction part 3 to a water repellent treatment. For example, as illustrated in FIG. 17, in the switch device 1, a water repellent treatment portion 16 subjected to a water repellent treatment may be formed on the guiding inlet 5, or on the guiding inlet 5 and the conduit wall 7a of the guiding conduit 7. This enables liquid entering via the guiding inlet 5 to be effectively guided to the reaction part 3 in the switch device 1. In addition, by subjecting the guiding inlet 5 or the guiding conduit 7 to a water repellent treatment, in states other than a wet state which should activate the switch device 1, small volumes of liquid can be repelled and not allowed to enter the housing 4, thereby preventing improper activation and ensuring reliability as a sensor.

Moreover, in the switch device 1, an interior wall of the housing 4 may be subjected to a water repellent treatment. By subjecting the interior wall of the housing 4 to a water repellent treatment, liquid entering the housing 4 is effectively guided to the reaction part 3, thus enabling rapid action of the reaction part 3.

As illustrated in FIG. 18, in the switch device 1, the guiding inlet 5 may be blocked by a water-soluble sealing material 9 in a sheet shape which dissolves in liquid. As in the liquid-soluble material 3a, the water-soluble sealing material 9 may be formed of natural polymers such as agar and gelatin, semisynthetic polymers such as cellulose and starch, and synthetic polymers such as polyvinyl alcohol, among others. As illustrated in FIG. 18, the water-soluble sealing material 9 may be formed into a sheet shape and used to block the guiding inlet 5 by pasting to the top surface of the housing 4. By blocking the guiding inlet 5 with the water-soluble sealing material 9, in states other than wet states which should activate the switch device 1, small volumes of liquid can be repelled and not allowed to enter the housing 4, thereby preventing improper activation and ensuring reliability as a sensor.

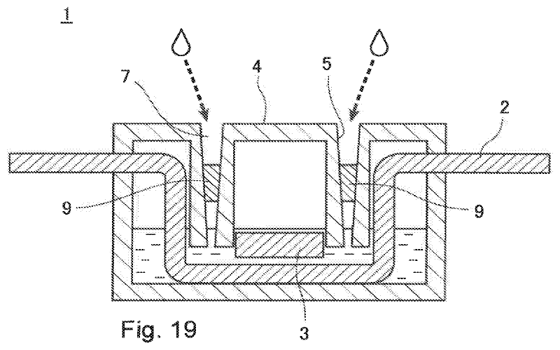

Similarly, in the switch device 1, as illustrated in FIG. 19, the guiding conduit 7 may be blocked by the water-soluble sealing material 9 which is dissolved by the liquid. By blocking the guiding conduit 7 with the water-soluble sealing material 9, small amounts of liquid can be repelled and not allowed to enter the housing 4, thereby preventing improper activation.

Housing Mating Portion Conduit

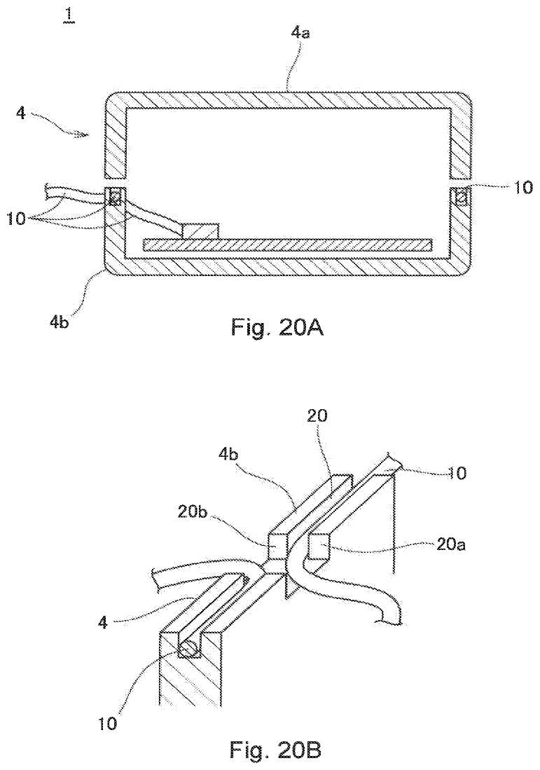

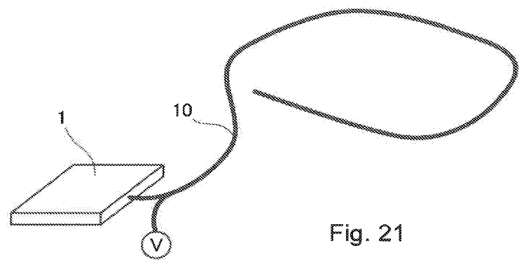

As illustrated in FIGS. 20 and 21, in the switch device 1, the housing 4 may be constituted by upper and lower halves 4a, 4b which are butted and joined together, and a wiring conduit 20 in which the twisted wire 10 is arranged may be provided on a surface of a side wall to be butted of one or both of the upper and lower halves 4a, 4b. The wiring conduit 20 is formed on one or both of the upper and lower halves 4a, 4b along a surface to be butted around the whole or a portion of the perimeter thereof.

A first lead recess 20a for leading the twisted wire 10 into the interior of the housing 4 may be formed in the wiring conduit 20. The twisted wire 10 is led through the first lead recess 20a and, for example, connected to the external-connection terminals 13a, 13b provided in the housing 4, or is connected to a heat generator 28 provided within the housing 4 in a protective device 23, 24 to be described below. Moreover, in the wiring conduit 20, when liquid enters the housing 4, the liquid flows through the first lead recess 20a and accumulates, thereby dissolving the liquid-soluble material 3a which coats the conductive wires 11A, 11B constituting the twisted wire 10 so that the conductive wires 11A, 11B are electrically connected.

Furthermore, as illustrated in FIG. 20 (B), a second lead recess 20b for leading the twisted wire 10 to the exterior of the housing which also serves as a guiding inlet for the liquid may be formed in the wiring conduit 20. As illustrated in FIG. 21, the twisted wire 10 is led out through the second lead recess 20b and connected to connection terminal of the external circuit. Moreover, in the wiring conduit 20, in a wet state, the liquid flows through the second lead recess 20b and accumulates, thereby dissolving the liquid-soluble material 3a which coats the conductive wires 11A, 11B constituting the twisted wire 10, thus electrically connecting the conductive wires 11A, 11B.

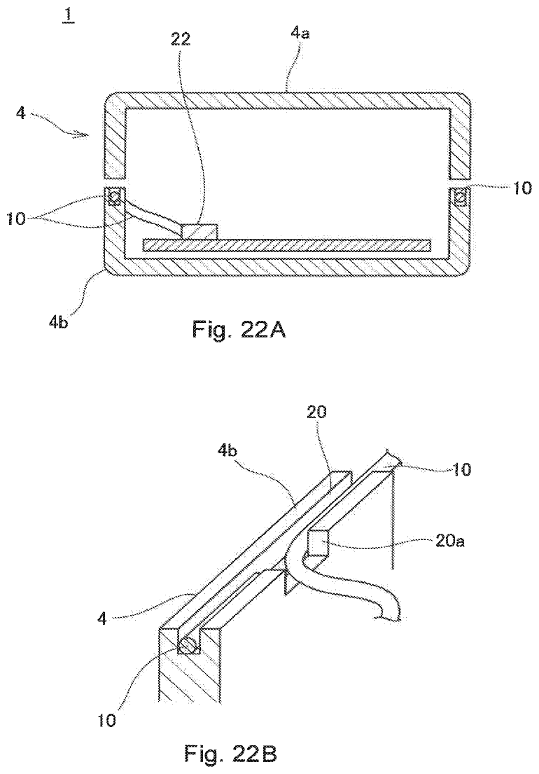

As the housing 4, the switch device 1 may use the housing of an electronic appliance of any type such as a personal computer, smartphone, tablet terminal, or battery pack in which the switch device 1 is used. In this case as well, as illustrated in FIG. 22 (A), in the switch device 1, the wiring conduit 20 in which the twisted wire 10 is arranged may be formed on one or both of the upper and lower halves 4a, 4b in a surface of a side wall to be butted. In this case, as illustrated in FIG. 22 (B), it is sufficient to form only the first lead recess 20a for leading the twisted wire 10 into the housing 4 in the wiring conduit 20.

The conductive wires 11A, 11B constituting the twisted wire 10 are connected to an external circuit 22 such as a protective circuit provided in the housing 4 and interrupt the external circuit 22 under normal conditions. Then, when water enters the housing 4, such as by being submerged in water, and enters the wiring conduit 20 through the first lead recess 20a, the liquid-soluble material 3a which coats the conductive wires 11A, 11B is dissolved, thereby electrically connecting the conductive wires 11A, 11B and activating the external circuit 22 to initiate a protective operation. In this case, adjustments such as forming the wiring conduit 20 in a lower position in the housing 4 allow adjustment of the amount of entering water that will enter the wiring conduit 20, thus the amount of entering water that will initiate action of the external circuit 22.

Circuit Configuration

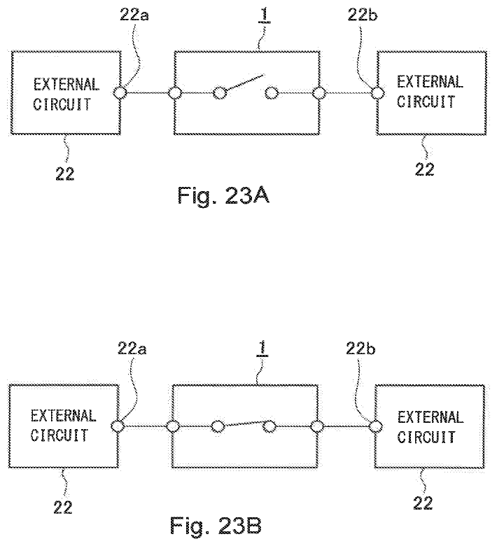

FIG. 23 is a circuit diagram of the switch device 1. Thus, in the switch device 1, the conductor 2 is connected to one open end 22a of the external circuit 22 and to the other open end 22b of the external circuit 22, and the reaction part 3 made of the liquid-soluble material 3a opens the external circuit (FIG. 23 (A)). Then, in the switch device 1, when the liquid enters the housing 4 in a wet state, the liquid-soluble material 3a of the reaction part 3 dissolves, thereby allowing current to flow through the conductor 2 and electrically connecting the open terminals 22a, 22b of the external circuit 22 (FIG. 23 (B)).

Therefore, by connecting the external circuit 22 such as an alarm circuit for outputting an alarm, a protective circuit for interrupting a charging/discharging path of a battery, or a backup circuit, these external circuits can be activated in response to an abnormality such as wetting with water or liquid leaking from a battery.

Protective Circuit

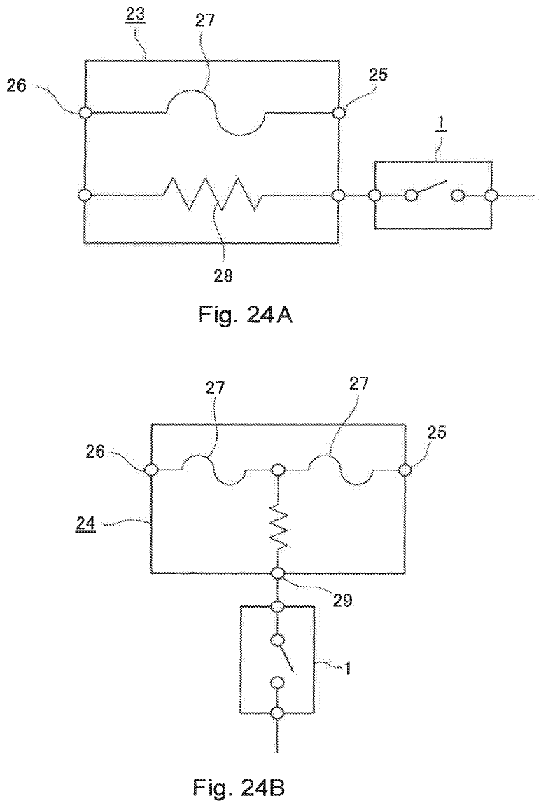

FIGS. 24 (A) and (B) are circuit diagrams each representing circuit configurations of the switch device 1 connected to a protective device 23 or 24 for interrupting an external circuit when an abnormality such as wetting with water occurs. As illustrated in FIG. 24 (A), a protective device 23 includes a first electrode 25 connected to one open end of an external circuit, a second electrode 26 connected to the other open end of the external circuit, a fuse element 27 mounted between the first and second electrodes 25, 26 to electrically connect the first and second electrodes 25, 26, and a heat generator 28 which generates heat when current flows and which blows out the fuse element 27.

By electrically connecting the first and second electrodes 25, 26 via the fuse element 27 under normal conditions, the protective device 23 allows current to flow through the external circuit. The heat generator 28 is connected on one end to a power source (not illustrated) and is connected on the other end to the conductor 2 of the switch device 1 which controls the flow of current; under normal conditions, the conductor 2 is electrically insulated, thus restricting the flow of current.

In the protective device 23, when an abnormality occurs such as wetting with water or liquid leaking from a battery, liquid enters the housing 4 of the switch device 1 and dissolves the liquid-soluble material 3a of the reaction part 3; thereby, current flows through the conductor 2 and powers the heat generator 28, which generates heat. In the protective device 23, it is thereby possible to blow out the fuse element 27 between the first and second electrodes 25, 26 and interrupt the external circuit.

Current to the heat generator 28 is stopped, for example, by a timer after a sufficient time for blowing out the fuse element 27 elapses. Alternatively, a sensor for detecting interruption of the external circuit may be provided to stop current to the heat generator 28 after detecting interruption of the external circuit.

FIG. 24 (B) is a diagram representing a circuit configuration of a protective device 24 in which the fuse element 27 is electrically connected to the heat generator 28, and the heat generator 28 is powered using the current path of the external circuit. In the protective device 24, under normal conditions, the first and second electrodes 25, 26 are electrically connected via the fuse element 27 and current is allowed to flow through the external circuit. The heat generator 28 is connected on one end to the fuse element 27 via a heat generator lead-electrode and connected on the other end to the conductor 2 of the switch device 1, by which the flow of current is controlled, via a heat generator power-supply electrode 29; under normal conditions, the conductor 2 is electrically insulated, thus restricting the flow of current.

In the protective device 24, when an abnormality occurs such as wetting with water or liquid leaking from a battery, liquid enters the housing 4 of the switch device 1 and dissolves the liquid-soluble material 3a of the reaction part 3; thereby, current flows through the conductor 2 and powers the heat generator 28, which generates heat. In the protective device 24, it is thereby possible to blow out the fuse element 27 between the first and second electrodes 25, 26 and interrupt the external circuit.

Because the current path is interrupted by blowout of the fuse element 27, current to the heat generator 28 is stopped.

Method of Using Protective Device

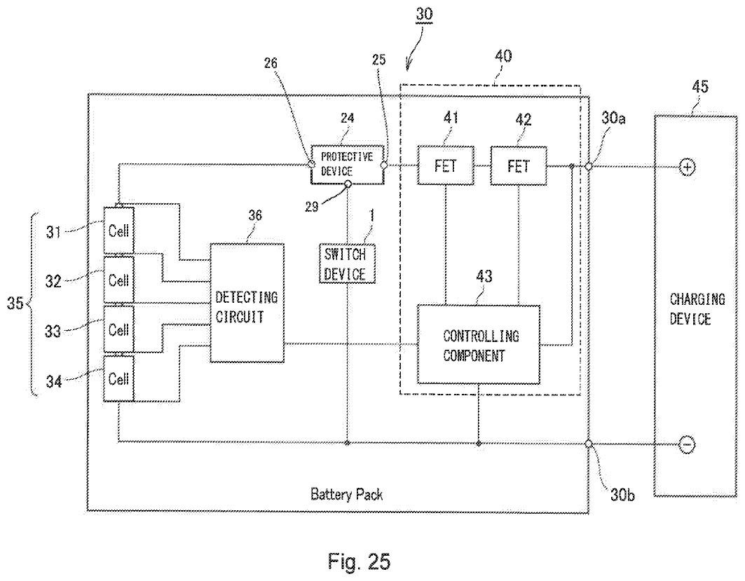

Next, an example of using these protective devices 23, 24 will be explained. It should be noted that, although the protective device 24 is described below, the same applies to the protective device 23. As illustrated in FIG. 25, the protective device 24 is incorporated, for example, in a circuit of battery pack 30 of a lithium ion secondary battery. The battery pack 30 includes a battery stack 35 including, for example, a total of four lithium ion secondary battery cells 31 to 34.

The battery pack 30 includes the battery stack 35, a charging/discharging controlling circuit 40 for controlling charging/discharging of the battery stack 35, and the switch device 1 for controlling operation of the protective device 24.

The battery stack 35 includes the battery cells 31 to 34, which are connected in series and require control for protecting against overcharge and overdischarge states and can be removably connected to a charging device 45 via a positive electrode terminal 30a and a negative electrode terminal 30b of the battery pack 30 across which the charging device 45 applies a charging voltage. The battery pack 30 thus charged by the charging device 45 can be connected to a battery-driven electronic appliance via the positive electrode terminal 30a and negative electrode terminal 30b to allow operation of the electronic appliance.

The charging/discharging controlling circuit 40 includes two current controlling devices 41, 42 connected in series in the current path from the battery stack 35 to the charging device 45 and includes a controlling component 43 for controlling operation of these current controlling devices 41, 42. The current controlling devices 41, 42 are constituted, for example, by field effect transistors (hereinafter referred to as FET) and the controlling component 43 controls gate voltage to control electrical connection/interruption of the current path of battery stack 35 in the charge direction and/or discharge direction. The controlling component 43 is powered by the charging device 45 and, in accordance with a detection signal from a detecting circuit 36, controls operation of the current controlling devices 41, 42 to interrupt the current path when overdischarge or overcharge occurs in the battery stack 35.

The protective device 24 is connected, for example, in a charging/discharging current path between the battery stack 35 and the charging/discharging controlling circuit 40, and operation thereof is controlled by the switch device 1.

The detecting circuit 36 is connected to each of the battery cells 31 to 34 to detect voltage values of each of the battery cells 31 to 34 and supplies the detected voltage values to the controlling component 43 of the charging/discharging controlling circuit 40. When an overcharge or overdischarge voltage is detected from one of the battery cells 31 to 34, the controlling component 43 outputs a control signal for controlling the current control devices 41, 42.

In the battery pack 30 having a configuration such as described above, the protective device 24 has a circuit configuration in which the fuse element 27 is connected in series between the first and second electrodes 25, 26 and a heat generator 28 which melts the fuse element 27 with heat when provided with current via a connection point with the fuse element 27. Furthermore, in the protective device 24, for example, the fuse element 27 is connected in series arrangement in the charging/discharging current path of the battery pack 30 via the first and second electrodes 25, 26; the heat generator 28 is connected on one end to a connection point with the fuse element 27 and on the other end to the conductor 2 of the switch device 1. The first electrode 25 of the protective device 24 is connected to one open end of the battery stack 35 and the second electrode 26 is connected to the positive electrode terminal 30a of the battery pack 30.

Blowout Process

In the protective device 24 having such a circuit configuration, in the case of needing to interrupt the current of the battery pack 30 such as when wet with water or battery liquid leaks, liquid having entered the housing 4, the switch device 1 powers the heat generator 28, which then generates heat. Then, in the protective device 24, heat generated by the heat generator 28 blows out the fuse element 27 incorporated in the current path of the battery pack 30. Thereby, reliable blowout between the first electrode 25 and the second electrode 26 as well as interruption of the current path of the battery pack 30 can be achieved with the protective device 24. Furthermore, by blowing out the fuse element 27, power supply to the heat generator 28 is stopped.

Thus, the switch device 1 functions as a control device for powering the heat generator 28 of the protective device 24 in response to such conditions as wetting with water or liquid leaking from a battery. This eliminates the necessity of control devices such as FETs for controlling electrical current to the heat generator 28.

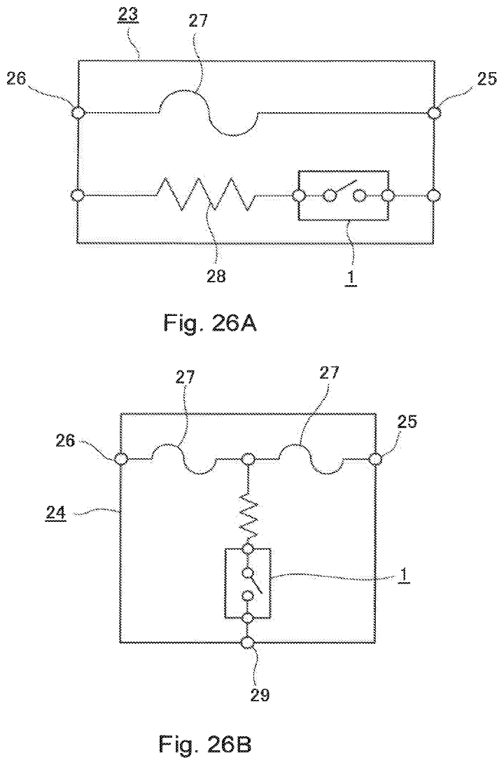

It should be noted that the, other than connecting to the switch device 1 provided externally, as illustrated in FIGS. 26 (A) and (B), the protective device 23, 24, may internally incorporate the switch device 1. Moreover, the protective device 23, 24 is not limited to use in battery packs of lithium ion secondary batteries and it is a matter of course that there are variety of applications requiring interruption of a conductive path using an electric signal.

### REFERENCE SIGNS LIST

1 switch device, 2 conductor, 3 reaction part, 3a liquid-soluble material, 4 housing, 5 guiding inlet, 6 discharging outlet, 7 guiding conduit, 9 water-soluble sealing material, 10 twisted wire, 11 conductive wire, 12 sponge metal, 13 external-connection terminal, 14 conductive particles, 15 agglomerated body, 16 water repellent treatment portion, 17 outer conductor, 17a opening, 17b insulating coating layer, 18 inner conductor, 18a insulating coating layer, 19 insulating film, 20 wiring conduit, 20a first lead recess, 20b second lead recess, 23 protective device, 24 protective device, 25 first electrode, 26 second electrode, 27 fuse element, 28 heat generator, 29 heat generator power-supply electrode, 30 battery pack, 31 to 34 battery cell, 35 battery pack, 36 detecting circuit, 40 charging/discharging controlling circuit, 41 current control device, 42 current control device, 43 controlling component, 45 charging device

1. A protective device comprising:
a first and a second electrode;
a heat generator;
a fusible conductor which is connected between the first and second electrodes and which is blown out by heat generated by the heat generator; and
a switch part provided on a power supply path of the heat generator, wherein the switch part comprises a conductor connected to a power source circuit of the heat generator, and a reaction part comprising a liquid-soluble material which opens the conductor and the power source circuit and which electrically connects the conductor and the power source circuit by being dissolved on contact with a liquid entering a device interior.

2. The protective device according to claim 1, further comprising:
a heat generator lead-electrode connected to the heat generator and the fusible conductor, wherein the fusible conductor constitutes a power supply path of the heat generator.
